(19) United States
(12) Patent Application Publication
(10) Pub. No.: US 2006/0087620 A1
(43) Pub. Date: Apr. 27, 2006

(54) COLOR MANAGEMENT METHOD OF A SPATIAL LIGHT MODULATOR

(76) Inventors: Ta-Shuang Kuan, Hsin-Chu Hsien (TW); Anthony Joseph Whitehead Jr., Hsin-Chu City (TW); Chia-Tsung Chan, Tao-Yuan Hsien (TW); Chia-Te Lin, Chia-Yi Hsien (TW)

Correspondence Address: NORTH AMERICA INTELLECTUAL PROPERTY CORPORATION, P.O. BOX 506, MERRIFIELD, VA, 22116, US

(21) Appl. No.: 10/904,153

(22) Filed: Oct. 27, 2004

(51) Int. Cl. G03B 21/00

(52) U.S. Cl. 353/31

(57) ABSTRACT

A color management method of an SLM performs the color management function by forming a plurality of micro color filters corresponding to each pixel, and adjusting the transmission rate of the micro color filters.

### BACKGROUND OF INVENTION

1. Field of the Invention

The present invention relates to a color management method of a spatial light modulator (SLM), and more particularly, to a method which integrates the color separation system into an LCOS projection system.

2. Description of the Prior Art

Spatial light modulator (SLM) is an application of the photoelectric system, which enables adjustment of wavelengths, phases, and polarization of light. The SLM has been utilized with various digital products and technology fields for optical signal treatments, amplifying images, and transferring incoherent light into coherent light. Among different SLMs, liquid crystal on silicon (LCOS) projection systems combine the technologies of semiconductors and LCDs, and have the advantages of high resolution, high brightness, simple structure, low cost, etc. As a result, the LCOS projection systems are highly potential in the development of digital projection technologies.

Please refer to FIG. 1, which is a schematic diagram of a color separation method of a conventional LCOS projection system 10. As shown in FIG. 1, the LCOS projection system 10 includes an optical engine 12, a color separation system 14, and an LCOS display panel 16. The optical engine 12 includes at least a high intensity discharge (HID) lamp, such as a xenon lamp, for providing a high brightness white light source. The color separation system 14 works to divide the white light source emitted from the optical engine 12 into three primary colors including red, green, and blue, and deliver the three primary colors to the LCOS display panel 16. Accordingly, the LCOS projection system 10 can project colorful images. The color separation system 14 can be classified into optical type and color wheel type. The optical type color separation system is for use in a three-panel type LCOS projection system, and separates white light by means of combinations of reflecting lenses, dichroic lenses, prisms, condensing lenses, etc. The incident white light generated by the optical engine 12 is divided into red, green, and blue light beams, and is respectively transferred to three different LCOS display panels. The color wheel type color separation system, used in a single-panel LCOS projection system, utilizes a rotary color wheel to transform white light generated by the optical engine 12 into red, green, and blue light beams in sequence, and deliver the red, green, and blue light beams to an LCOS display panel consecutively. As a result, viewers can see color projection images due to vision persistence characteristic of human eyes.

For the conventional LCOS projection system, the white light source has to be separated by the color separation system, and then delivered to the LCOS display panel so as to display colorful images. However, either the color wheel type separation system or the optical type color separation system occupies considerable space, and leads to the size increase of the LCOS projection system. In addition, the conventional LCOS projection system fails to manage and arrange colors while forming the LCOS display panel. The color management and arrangement can only be performed by an OSD (on screen display) adjustment function until the LCOS projection system is completely fabricated. Therefore, how to integrate the color separation system of the LCOS projection system so as to reduce the size, and perform color management before the LCOS display panel is fabricated is an issue to study.

### SUMMARY OF INVENTION

It is therefore a primary object to provide a color management method of a spatial light modulator for overcoming the aforementioned problems.

According to a preferred embodiment of the present invention, a color management method of an LCOS projection system is provided. The LCOS projection system includes a plurality of pixel regions arranged in an array. First, a plurality of micro color filters corresponding to the pixel regions are formed in the LCOS projection system. Then, the color management is performed by controlling the transmission rate of the micro color filters.

Since a plurality of micro color filters are installed into the LCOS projection system, color separation is fulfilled. In addition, by adjusting the transmission rate of each micro color filter, the color management is further implemented.

These and other objectives of the present invention will no doubt become obvious to those of ordinary skill in the art after having read the following detailed description of the preferred embodiment that is illustrated in the various figures and drawings.

### BRIEF DESCRIPTION OF DRAWINGS

FIG. 1 is a schematic diagram of a color separation method of a conventional LCOS projection system.

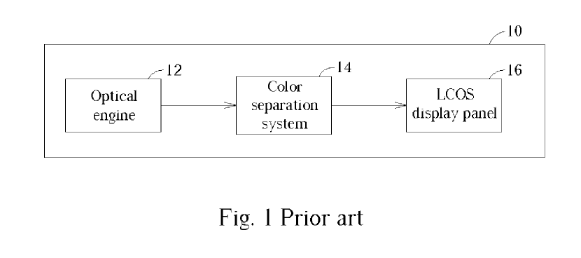

FIG. 2 is a schematic diagram of a color management method of an LCOS projection system.

FIG. 3 is a schematic diagram of an LCOS display panel according to a preferred embodiment of the present invention.

### DETAILED DESCRIPTION

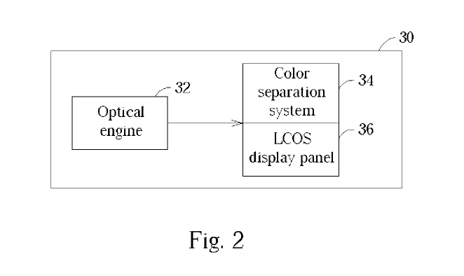

Please refer to FIG. 2, which is a schematic diagram of a color management method of an LCOS projection system 30. As shown in FIG. 2, the LCOS projection system 30 includes an optical engine 32, a color separation system 34, and an LCOS display panel 36. The optical engine 32 includes at least a high intensity discharge (HID) lamp, such as a xenon lamp, for providing a high brightness white light source. Remarkably, the color separation system 34 is installed inside the LCOS display panel 36 by means of forming a plurality of micro color filters corresponding to the pixel regions. Accordingly, the white light transferred from the optical engine 32 is separated into red, green, and blue light beams inside the LCOS display panel 36. Consequently, the size of the LCOS projection system 30 is greatly reduced.

As described, the color management method of the present invention integrates the color separation system 34 into the LCOS display panel 36. The white light source is directly delivered to the LCOS display panel 36, separated by the color separation system 34 (micro color filters), and then reflected out of the LCOS display panel 36.

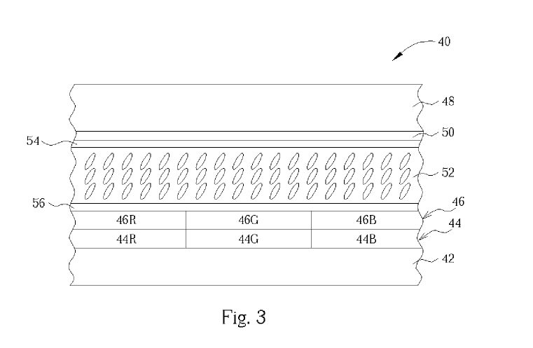

For illustrating the mechanism of color separation and management function of the present invention, please refer to FIG. 3. FIG. 3 is a schematic diagram of an LCOS display panel 40 according to a preferred embodiment of the present invention. As shown in FIG. 3, the LCOS display panel 40 includes a back plane 42, a plurality of pixel electrodes 44 positioned on the back plane 42, a plurality of micro color filters 46 positioned on and corresponding to the pixel electrodes 44, a front plane 48 positioned above the back plane 42, a transparent conductive layer 50 positioned on the surface of the front plane facing the back plane 42, and a liquid crystal layer 52 interposed in between the micro color filters 46 and the transparent conductive layer 50. In addition, the LCOS display panel 40 further includes a top alignment layer installed on the surface of the transparent conductive layer 50, and a bottom alignment layer 56 installed on the surface of the micro color filters 46. It is noted that only three pixel electrodes 44R, 44G, and 44B, and three micro color filters 46R, 46G, and 46B are drawn for highlighting the characteristic, where R, G, and B respectively represent a red pixel, a green pixel, and a blue pixel.

The present invention is characterized by respectively forming the micro color filters 46R, 46G, and 46B on the pixel electrodes 44R, 44G, and 44B, so that the incident white light is separated in red light, green light, and blue light in corresponding pixel regions, and respectively reflected by the pixel electrodes 44R, 44G, and 44B. It is to be noted that the micro color filters 46 are also able to provide a color management function. Since the micro color filters 46R, 46G, and 46B are corresponding to each pixel region of the LCOS display panel 40, the light transmission rate of each pixel region can be easily adjusted by altering the thickness, shape, area, arrangement, compositions, etc, of the micro color filters 46R, 46G, and 46B. Accordingly, the color effect, such as color temperature, can be designed when forming the LCOS display panel 40. For example, if an LCOS projection system 30 having a preset low color temperature is desired, the low color temperature effect (reddish image) can be easily accomplished by increasing the transmission rate of micro color filter 46R. In this embodiment, the micro color filters 46 are composed of a plurality of optical thin films, and the transmission rate can be precisely controlled by adjusting the composition, thickness, shape, area, arrangement, etc. Consequently, the color management is feasible when forming the LCOS display panel 40.

It can be seen that the present invention integrates the color separation system into the LCOS display panel so as to perform the color separation function inside the LCOS display panel. Moreover, the micro color filters installed inside the LCOS display panel make it possible to perform the color management function. It is remarkable that the micro color filters are composed of a plurality of optical thin films in the above embodiment. Nevertheless, the micro color filters are not limited, and can be made of any suitable single material as long as the light transmission rate can be easily adjusted. In addition, the micro color filters can also be installed in other positions of the LCOS display panel where proper.

In comparison with the prior art, the color management of the present invention not only reduces the cost and size of LCOS projection systems, but also provides the color management function. Consequently, the color display effect of the LCOS projection system is improved.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A color management method of a spatial light modulator (SLM), the SLM comprising a plurality of pixel regions arranged in an array, the color management method comprising:
forming a plurality of micro color filters corresponding to each pixel region in the SLM; and
controlling a transmission rate of each micro color filter to manage colors of the SLM.

2. The color management method of claim 1, wherein the SLM is an LCOS projection system, and the LCOS projection system further comprises:
an optical engine; and
an LCOS display panel comprising:
a back plane;
a front plane positioned above the back plane; and
a liquid crystal layer interposed in between the back plane and the front plane.

3. The color management method of claim 2, wherein the micro color filters are positioned in the back plane.

4. The color management method of claim 1, wherein the micro color filters comprise a plurality of optical thin films.

5. The color management method of claim 4, wherein the micro color filters comprise a plurality of red micro color filters, a plurality of green micro color filters, and a plurality of blue micro color filters.

6. The color management method of claim 5, further comprising adjusting a transmission rate of red visible light beams by altering thicknesses and compositions of the red micro color filters.

7. The color management method of claim 5, further comprising adjusting a transmission rate of green visible light beams by altering thicknesses and compositions of the green micro color filters.

8. The color management method of claim 5, further comprising adjusting a transmission rate of blue visible light beams by altering thicknesses and compositions of the blue micro color filters.

9. A color management method of a spatial light modulator (SLM), the SLM comprising a back plane having a plurality of pixel regions arranged in an array, the color management method comprising:
forming a plurality of micro color films corresponding to each pixel region in the SLM, the micro color films comprising a plurality of red micro color films, a plurality of green micro color films, and a plurality of blue micro color films; and
controlling transmission rates of the micro color films to manage colors of the SLM.

10. The color management method of claim 9, wherein the SLM is an LCOS projection system, and the LCOS projection system further comprises:
an optical engine; and
an LCOS display panel comprising:
a back plane;
a front plane positioned above the back plane; and
a liquid crystal layer interposed in between the back plane and the front plane.

11. The color management method of claim 9, further comprising adjusting a transmission rate of red visible light beams by altering thicknesses and compositions of the red micro color films.

12. The color management method of claim 9, further comprising adjusting a transmission rate of green visible light beams by altering thicknesses and compositions of the green micro color films.

13. The color management method of claim 9, further comprising adjusting a transmission rate of blue visible light beams by altering thicknesses and compositions of the blue micro color films.
